(19) United States
(12) Patent Application Publication
(10) Pub. No.: US 2010/0077024 A1
(43) Pub. Date: Mar. 25, 2010

(54) METHOD FOR TRANSMITTING DATA TRANSMITTED INCOMPLETELY BETWEEN SERVER AND CLIENT

(75) Inventor: Seok-Tae Yun, Seoul (KR)

Correspondence Address: HARNESS, DICKEY & PIERCE, P.L.C., P.O. BOX 828, BLOOMFIELD HILLS, MI, 48303, US

(73) Assignee: POINT-I CO., LTD., Seoul (KR)

(21) Appl. No.: 12/527,121

(22) PCT Filed: Feb. 15, 2008
(86) PCT No.: PCT/KR08/00914

§ 371 Date: Aug. 13, 2009

(30) Foreign Application Priority Data
Feb. 16, 2007 (KR) 10-2007-0016673

(51) Int. Cl. G06F 15/16

(52) U.S. Cl. 709/203

(57) ABSTRACT

There is provided a method for data transmission in a communication system, including: transmitting part of data to be transmitted from one terminal to another terminal depending on a maximum transmission tolerable capacity; when the transmission of the data is stopped during the transmission, storing information on a capacity of the partial data lastly validly transmitted from said another terminal and information on a corresponding session; when a next session begins after stop of the current session, transmitting the information from said another terminal to said one terminal to recognize the information as a session upon restart; and finding, at said one terminal, data at the time when the transmission is stopped, and transmitting the data following partial data at the stopping time to said another terminal.

### TECHNICAL FIELD

The preset invention relates to a method for transmitting data incompletely transmitted between a server and a client using a Synchronization Markup Language (SyncML), and a computer-readable recording medium that stores a software program for realizing the method.

More specifically, the present invention is to ensure that, when a session is abnormally stopped due to a narrow bandwidth and the influence of internal/external environment of a system during the transmission of a large capacity of files between a server and a client, in the process of Data Synchronization (DS) between the server and the client using SyncML and data download from the server to the client or Device Management (DM), the invention detects any data having data exchanged (“incompletely transmitted data”) under a previous abnormal state (or the state where transmission has not been completed) at the time of execution of a next session, and makes data transmission from the stopping time.

### BACKGROUND ART

In mobile communication terminals and portable devices (camera, PDA, etc.), users tend to store, in their individual terminals, necessary information such as an address book and schedule information and the like, and multimedia files or documents created by them or downloaded such as photos and music files, and then use them. In addition, in the case of using a new terminal due to replacement or loss of an existing terminal, users may wish to transfer the information stored in their own terminals to new terminals for its use. Moreover, users having various portable terminals (portable PC, PDA, mobile communication terminal, etc.) may wish to share and use their own data among different terminals.

In this case, what is required is a data synchronization technology for users who want to share and transfer the same data, regardless of whether or riot there are different types of terminals.

The data synchronization technology is a technology which synchronizes data between a terminal and another terminal or a terminal and a server so that a data change in a terminal is equally applied to another terminal through the use of a data synchronization server.

However, a synchronization technology, which is not compatible with each other, makes the tasks of users, manufacturers of devices, service providers, application developers complicated, and the absence of common data synchronization technology lowers the grown of use of mobile devices and limits users' data access and delivery of mobile data services.

Hence, Open Mobile Alliance (OMA), the group of companies associated with wireless communications, tried to make the standard for wireless communication technology, and has established SyncML DS which is the standard for management of wireless mobile communication terminals based on SyncML.

SyncML is an international standard language to synchronize data between different devices and application services over a network. This SyncML achieves data synchronization between a server and a device by communicating a message having data represented in the form of Extensible Markup Language (XML) between them. In other words, this is done by having common data synchronized with each other amongst several distributed terminals.

On the other hand, individual's possession of various mobile communication terminals and access to various information become necessary in the life of today under the ubiquitous environments. Therefore, as the use of mobile communication terminals is universal and a service area is extended, their hardware and software become gradually complicated and diversified.

This has issued problems associated with the management of mobile communication terminals. Generally, since a method that manipulates and manages mobile communication terminals is dependent upon a peculiar way provided by manufacturer of each terminal, it is impossible to check the hardware and software conditions of mobile communication terminals or provide services for installment of application software in a consistent manner instead of users under the existing wireless environment. For this reason, the manufacturers and service provides as well as general users have to pay much costs for management of mobile communication terminals. This management problem also occurs in an automobile information system, a home gateway, a kiosk, a set-top box, etc., in addition to the mobile communication terminals.

Thus, OMA tried to make the standard for wireless communication technology, and has established SyncML DS which is the standard for management of wireless communication terminals based on SyncML. This standard extends SyncML DS that is the data synchronization technology in the mobile communication environment to the management purpose, and serves to achieve management by way of exchange of management information between a management server (SyncML server) and a management agent (SyncML client).

The terminal management technology is a technology which remotely carries out the tasks of upgrade of firmware, installation and upgrade of application, diagnosis and management of terminal, and the like for products such as a personal portable telephone, PDA, computer, and so on.

FIG. 1 is an explanatory diagram showing an environment to which a conventional data synchronization process between a SyncML client and a SyncML server is applied. It should be noted that the data download to the client from the server or device management (DM) technology can equally be applied to the environment. Hereinafter, a data synchronization process will mainly be described in detail.

When the SyncML client 10 transmits a message having updated data to the SyncML server 20, the SyncML server 20 performs a synchronization task with server side's data depending on the type of synchronization requested by the SyncML client 10, and then transmits the task result to the SyncML client 10.

The data synchronization process undergoes this message exchange several times, and, after normal execution, maintains the same state for application program data in question between the SyncML client 10 and the SyncML server 20.

The SyncML client 10 is mounted on a mobile device such as a PDA, a mobile communication terminal, a laptop computer, and so on, and can perform data synchronization, data download, or terminal management between several devices of one user or with the SyncML server 20.

Conventionally, a data synchronization task between a mobile communication terminal and a data synchronization server (or heterogeneous terminal) is executed at a user's request for synchronization or by a periodic automatic synchronization process. This data synchronization process between the terminal and the data synchronization server will now be described with reference to FIG. 2.

FIG. 2 is a flowchart describing a conventional large capacity data synchronization process between a SyncML client and a SyncML server.

In FIG. 2, a SyncML server 20 is a server that employs the SyncML protocol, and a SyncML client 10 is also a client that uses the same.

The conventional data synchronization method shown in FIG. 2 begins at 201 in which the SyncML client 10 requests the SyncML server 20 for synchronization. That is, the SyncML client 10 requests the SyncML server 20 to provide authentication information about the SyncML server 20 and the number of data to be performed for synchronization at 202. In response, the SyncML server transmits, to the SyncML client 10, authentication result if authentication is successful and the number of data to be executed for synchronization with the SyncML client 10 at 202. This process corresponds to a process for authentication of data synchronization and initialization.

Next, any change in the SyncML client 10 is first applied to the SyncML server 20 for its update at 203. Upon completion of application of any change in the SyncML client 10, any change in the SyncML server 20 is applied to the SyncML client 10 for its update at 204. That is, the change in the SyncML client 10 and the change in the SyncML 20 are applied to each other for synchronization with their respective counterpart's data.

The synchronization process is to correct, update, and delete data as required. The SyncML server 20 and the SyncML client 10 make change application requests and responses thereto in order to ensure the reliability for update of data to be changed. If both requests and responses are not completed, this means that data synchronization fails.

The above description is the case where the synchronization process has been normally performed. In the data synchronization between the SyncML client 10 and the SyncML server 20, however, there may frequently occur the case where the synchronization process has been abnormally stopped due to the traffic of network or internal or external factors.

A conventional synchronization processing method suitable to use in the event of fail of the synchronization process will be set forth below with reference to FIG. 3.

FIG. 3 is a flowchart describing a synchronization restart process in the event of abnormal stop of data transmission from a SyncML client to a SyncML server during a conventional large capacity data synchronization process between them.

In FIG. 3, it is assumed that the SyncML client 10 synchronizes two data by a user's data change.

First of all, the SyncML client 10 prepares a list of two changes of data to be transmitted to the SyncML server 20 upon occurrence thereof at 301. Next, the SyncML client 10 makes a connection to the SyncML server 20 and requests synchronization for the two changes (that is, the SyncML client 10 requests the SyncML server 20 to provide the number of data (“2”) to be performed for synchronization and authentication information of the SyncML server 20), and then, the SyncML server 20 accepts the request for synchronization after performing an authentication procedure at 302.

Thereafter, the SyncML client 10 transmits the first change (data 1) to the SyncML server 20 at 303. Then, the SyncML server 20 confirms that the transmission of the data of the SyncML client 10 has been normally completed and then stores it at 304.

Next, the SyncML client 10 tries to transmit the second change (data 2) at 305. If the second data (data 2) is a large capacity file, the SyncML client 10 divides the data 2 into several messages and then transmits them at 305. If the transmission has been abnormally stopped before completion thereof at 306, the SyncML server 20 deletes the partially transmitted data 2 (incompletely transmitted data 2) at 307, and treats it as unsynchronized one. Also, the SyncML client 10 handles the second data (incompletely transmitted data 2) as unsynchronized one.

Subsequently, upon arrival of a new synchronization point of time, synchronization is performed at 308, in which the SyncML client 10 prepares a list of changes for the second data (incompletely transmitted data 2) at 309, and then makes a connection to the SyncML server 20 and requests synchronization for one change (that is, the SyncML client 10 requests the SyncML server 20 to offer authentication information for the SyncML server 20 and the number of data (“1”) to be performed for synchronization). In response, the SyncML server 20 accepts the request for synchronization after executing an authentication procedure at 310.

Next, the SyncML client 10 divides the entire information on the incompletely transmitted data 2 into several messages and then transmits them to the SyncML server 20 at 311. After that, the SyncML server 20 confirms that the transmission of the data of the SyncML client 10 has been normally completed, and then stores it at 312, thereby establishing synchronization of the data and 2 between the SyncML client 10 and the SyncML server 20 at 313 and 314.

In this data synchronization process of a large capacity file, however, if data transmission is abnormally stopped while the SyncML server 20 and the

SyncML client 10 transmit details on their own changes, the entire data of the incompletely transmitted data should be transmitted again from the beginning thereof in a next synchronization session, which yields a waste of resources. As a result, this leads to an increase in synchronization time and a waste of unnecessary transactions.

FIG. 4 is a flowchart describing a terminal management restart process in the event of abnormal stop of data transmission from a SyncML server to a SyncML client during a conventional terminal management process between them.

First of all, the SyncML server 20 makes a connection to the SyncML client 10 and performs an authentication and initialization procedure at 401.

Next, the SyncML server 20 transmits large capacity data to the SyncML client 10 at 402 and 403. At this time, if the transmission of large capacity data is abnormally stopped before completion thereof at 404, the SyncML server 20 deletes transmission information on the partially transmitted large capacity data (incompletely transmitted data) at 405. Then, the SyncML client 10 also deletes the transmission information on the large capacity data partially transmitted (incompletely transmitted data) from the SyncML server 20 at 406.

Thereafter, when a new terminal management session starts at 407, the SyncML server 20 transmits the large capacity data (incompletely transmitted data) again from the beginning thereof in the restarted terminal management session, regardless of transmission of previous data. That is, after performing the authentication and initialization process at 408, the large capacity data (incompletely transmitted data) is transmitted again from the beginning thereof at 409 to 411. Subsequently, when the transmission of the large capacity data (incompletely transmitted data) is completed at 412, the SyncML server 20 transmits terminal management instruction to the SyncML client 10 at 413, thereby completing the terminal management session between the SyncML client 10 and the SyncML server 20 at 414 and 415.

In this terminal management process of large capacity file, however, if data transmission is abnormally stopped while the SyncML server 20 transmits data to the SyncML client 10, the entire data of the data (incompletely transmitted data) should be transmitted again form the beginning thereof, which yields a waste of resources. As a result, this leads to an increase in terminal management time and a waste of unnecessary transactions.

### DISCLOSURE

Technical Problem

An embodiment of the present invention is directed to providing a method for transmitting data incompletely transmitted between a server and a client using a Synchronization Markup Language (SyncML), and a computer-readable recording medium that stores a software program for realizing the method.

The present invention ensures that, when a session is abnormally stopped due to a narrow bandwidth and the influence of internal/external environment of a system during the transmission of a large capacity of files between a server and a client, in the process of Data Synchronization (DS) between the server and the client using SyncML and data download from the server to the client or Device Management (DM), the invention detects any data having data exchanged (“incompletely transmitted data”) under a previous abnormal state (or the state where transmission has not been completed) at the time of execution of a next session, and makes data transmission from the stopping time.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

Technical Solution

In accordance with an aspect of the present invention, there is provided a method for data transmission in a communication system, including: transmitting part of data to be transmitted from one terminal to another terminal depending on a maximum transmission tolerable capacity; when the transmission of the data is stopped during the transmission, storing information on a capacity of the partial data lastly validly transmitted from said another terminal and information on a corresponding session; when a next session begins after stop of the current session, transmitting the information from said another terminal to said one terminal to recognize the information as a session upon restart; and finding, at said one terminal, data at the time when the transmission is stopped, and transmitting the data following partial data at the stopping time to said another terminal.

In accordance with another aspect of the present invention, there is provided a method for data transmission in a communication system, including: transmitting part of data to be transmitted from one terminal to another terminal depending on a maximum transmission tolerable capacity; when the transmission of the data is stopped during the transmission, storing information on a capacity of the partial data lastly validly transmitted from said one terminal and information on a corresponding session; when a next session begins after stop of the current session, transmitting the information from said one terminal to said another terminal to recognize the information as a session upon restart; and finding, at said one terminal, data at the time when the transmission is stopped, and transmitting the data following partial data at the stopping time to said another terminal.

In accordance with another aspect of the present invention, there is provided a computer-readable storage medium, in a communication system having a processor for transmitting date incompletely transmitted, which stores a software program for realizing the functions including: when the transmission of the data is stopped during the transmission, storing information on a capacity of the partial data lastly validly transmitted from said another terminal and information on a corresponding session; when a next session begins after stop of the current session, transmitting the information from said another terminal to said one terminal to recognize the information as a session upon restart; and finding, at said one terminal, data at the time when the transmission is stopped, and transmitting the data following partial data at the stopping time to said another terminal.

In accordance with another aspect of the present invention, there is provided a computer-readable storage medium, in a communication system having a processor for transmitting data incompletely transmitted, which stores a software program for realizing the functions including: transmitting part of data to be transmitted from one terminal to another terminal depending on a maximum transmission tolerable capacity; when the transmission of the data is stopped during the transmission, storing information on a capacity of the partial data lastly validly transmitted from said one terminal and information on a corresponding session; when a next session begins after stop of the current session, transmitting the information from said one terminal to said another terminal to recognize the information as a session upon restart; and finding, at said one terminal, data at the time when the transmission is stopped, and transmitting the data following partial data at the stopping time to said another terminal.

Advantageous Effects

In accordance with the present invention, when a data synchronization or terminal management session is unintentionally stopped by internal/external environments in a large capacity data synchronization or terminal management process between a server and a client, data transmission for the large capacity data having only partial data transmitted is restarted at the stopping time, thereby improving the efficiency of data transmission between the server and the client.

In addition, in accordance with the present invention, the client and the server do not transmit all of data that data synchronization fails, but transmit only data after the stopping time, thus decreasing a waste of unnecessary transactions upon synchronization of a large capacity data or terminal management and also reducing synchronization or terminal management time.

Furthermore, in accordance with the present invention (see FIG. 5 and another embodiment of FIG. 6), session information on the transmission stop is stored at the data receiving end, not the transmitting end, and the information is transferred to the transmitting end, so that continuous data transmission can be achieved, even in the case where the transmitting end cannot store data information lost, such as separation of battery during data transmission.

### BRIEF DESCRIPTION OF THE DRAWINGS

FIG. 1 is an explanatory diagram showing an environment to which a conventional data synchronization process between a SyncML client and a SyncML server is applied.

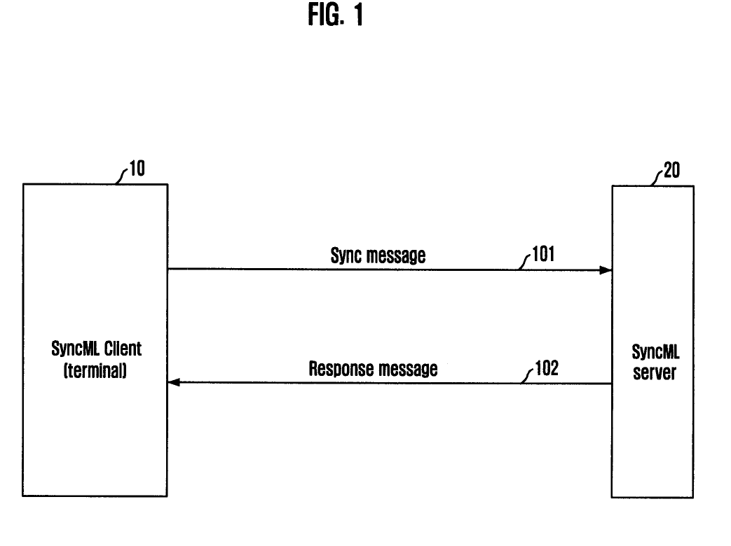

FIG. 2 is a flowchart describing a conventional large capacity data synchronization process between a SyncML client and a SyncML server.

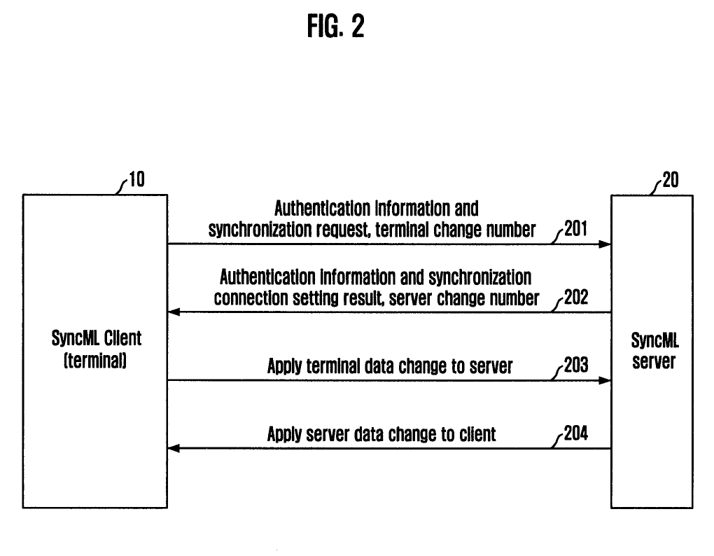

FIG. 3 is a flowchart describing a synchronization restart process in the event of abnormal stop of data transmission from a SyncML client to a SyncML server in a conventional large capacity data synchronization process between them.

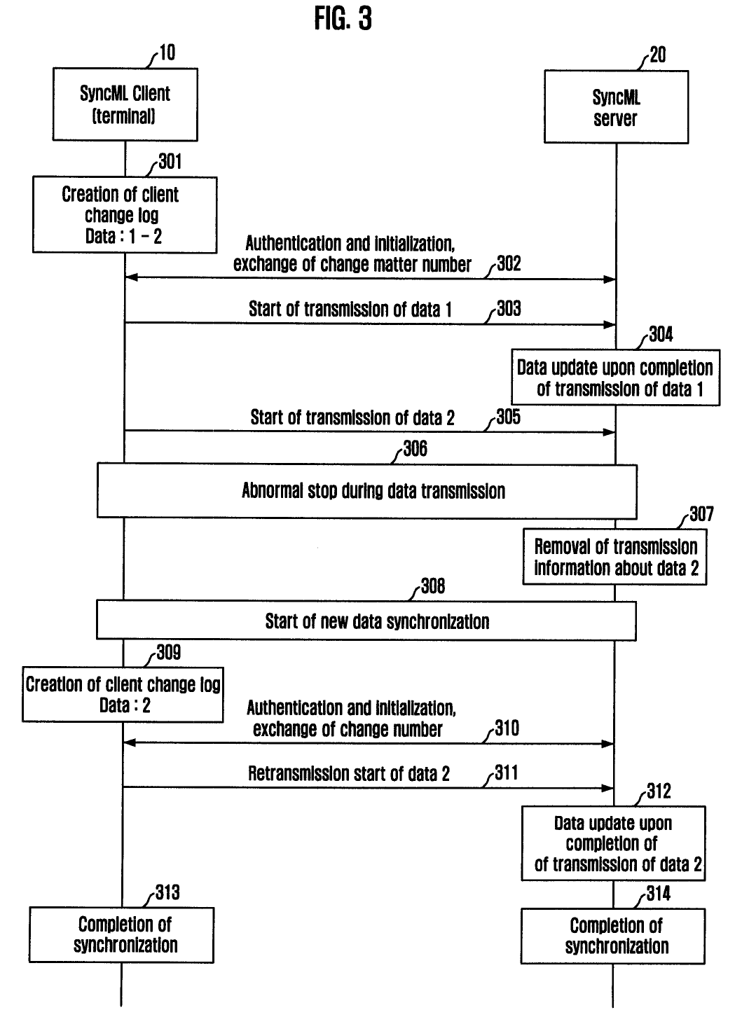

FIG. 4 is a flowchart describing a terminal management restart process in the event of abnormal stop of data transmission from a SyncML server to a SyncML client in a conventional terminal management process between them.

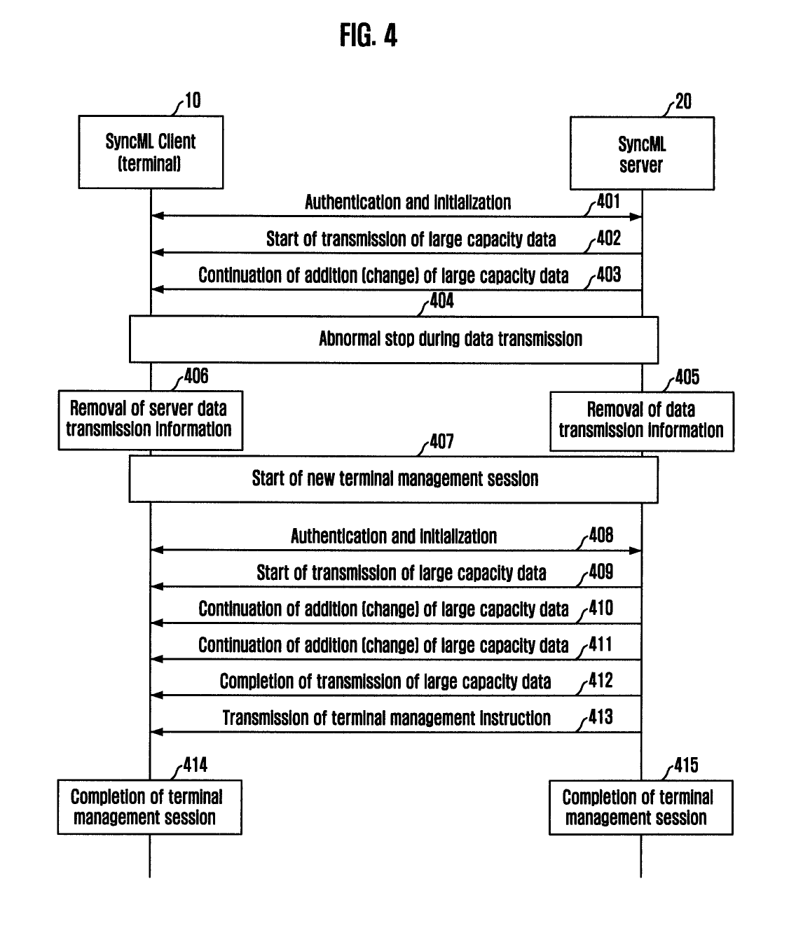

FIG. 5 is a flowchart describing a synchronization restart process in the event of abnormal stop of data transmission from a SyncML client to a SyncML server in a method for transmission of data incompletely transmitted between them in accordance with a preferred embodiment of the present invention.

FIG. 6 is a flowchart describing a terminal management restart process in the event of abnormal stop of data transmission from a SyncML client to a SyncML server in a method for transmission of data incompletely transmitted between them in accordance with another preferred embodiment of the present invention.

FIG. 7 is a detailed flowchart showing the case where data transmission is abnormally stopped during transmission of data from the SyncML client to the SyncML server in FIG. 5.

FIG. 8 is a detailed flowchart showing a process in which the SyncML server continuously receives data from the SyncML client in FIG. 5.

FIG. 9 is a detailed flowchart showing the case where data transmission is abnormally stopped during transmission of data from the SyncML server to the SyncML client in FIG. 6.

FIG. 10 is a detailed flowchart showing a process in which the SyncML client continuously receives data from the SyncML server in FIG. 6.

### BEST MODE FOR THE INVENTION

The advantages, features and aspects of the invention will become apparent from the following description of the embodiments with reference to the accompanying drawings, which is set forth hereinafter, and thus, the present invention will easily be carried out by those skilled in the art. Further, in the following description, well-known arts will not be described in detail if they could obscure the invention in unnecessary detail. Hereinafter, preferred embodiments of the present invention will be described in detail with reference to the accompanying drawings.

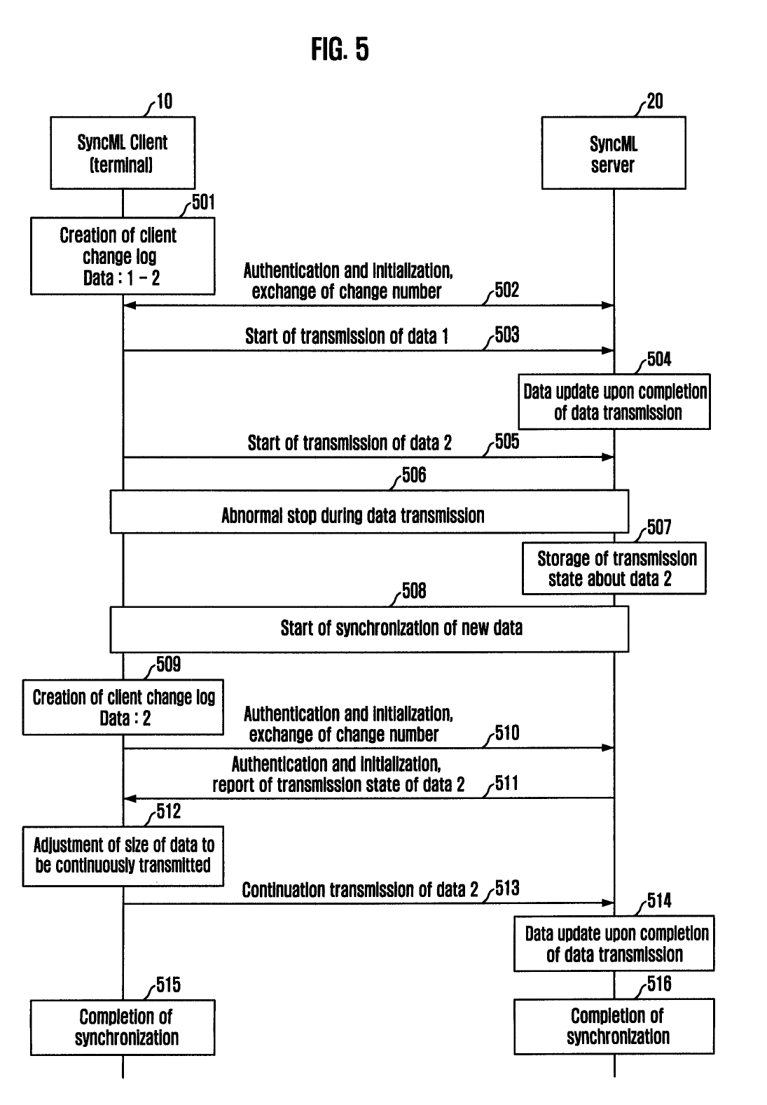

FIG. 5 is a flowchart describing a synchronization restart process in the event of abnormal stop of data transmission from a SyncML client to a SyncML server in a method for transmission of data incompletely transmitted between them in accordance with a preferred embodiment of the present invention. That is, FIG. 5 shows a process that detects necessary information and performs continuous data transmission in a next session upon fail of data transmission from the SyncML client 10 to the SyncML server 20.

According to FIG. 5, the present invention allows the SyncML server 20 to store information on current transmission state in a data synchronization process at the time of an abnormal stop (or at the time when transmission is not completed), and then exchange the information on incompletely transmitted data with the SyncML client 10 upon start of a next session. By doing so, the present invention detects data that is partially transmitted from the SyncML client 10, and transmits only the remainder of that data to the SyncML server 20, thereby decreasing the amount of data to be transmitted in the synchronization process upon exchange of large capacity data, synchronization time, a waste of unnecessary transactions, and so on.

In other words, when the transmission of large capacity data is stopped during transmission due to an abnormal stop (incomplete transmission) in the data synchronization process, the present invention allows the SyncML server 20 to store information on an abnormally stopped session (or a session that transmission is not completed) and data transmission state information in the abnormally stopped session (stopped (incompletely transmitted) data management information, a data size, progress details of data (a size of transmitted data), etc.). Further, upon start of a next synchronization session, the SyncML server 20 transmits the stored information (the information on the abnormally stopped session (or the session that transmission is not completed) and the data transmission state information on the abnormally stopped session) to the SyncML client 10 at the SyncML client 10′ request or in the authentication and initialization process, to inform the SyncML client 10 that there was partial transmission of the large capacity data (fail of data transmission) before the start of the current session to find out that the current session is a resume session. Then, the SyncML client 10 detects data at the time when transmission is stopped by using the above information and initiates to transmit the data from the stopping time, and the SyncML server 20 taking over the data sequentially updates the data following the pre-stored data to achieve synchronization.

Here, upon exchange of data between the SyncML client 10 and the SyncML server 20, the SyncML server 20 can manage the information on the abnormally stopped session (or the session that transmission is not completed) and data transmission state information (stopped (incompletely transmitted) data management information in the abnormally stopped session, a data size, progress details of data, etc.) and exchange them with the SyncML client 10, thereby enabling continuous data reception. At this time, when the SyncML server 20 exchanges session information with the SyncML client 10, it stores the session information in a specific node and manages it, and, upon start of data synchronization session, the SyncML client 10 requests the SyncML server 20 to provide the information on the node, or the SyncML server 20 transmits the information to the SyncML client 10 in the authentication and initialization process. As such, the SyncML server 20 informs the SyncML client 10 that there was partial transmission of data (fail of data transmission) in the previous session (to find out that the current session is a resume session), thereby taking over data from the SyncML client 10.

Now, a data transmission and continuous data reception process from the SyncML client 10 to the SyncML server 20 will be described in more detail with reference to FIG. 5. In FIG. 5, it is assumed that the SyncML client 10 synchronizes two data according to a user's data change.

First, when there is any change in the SyncML client 10, the SyncML client 10 constitutes a list of changes to be transmitted to the SyncML server 20 at 501. Next, the SyncML client 10 performs an authentication and initialization process for exchange of data with the SyncML server 20 at 502. That is, the SyncML client 10 makes a connection to the SyncML server 20, and requests synchronization for the two changes (that is, the SyncML client 10 requests the SyncML server 20 to provide authentication information on the SyncML server 20 and the number of data (“2”) to be performed for synchronization). Then, the SyncML server 20 accepts the synchronization request after performing the authentication procedure.

Thereafter, upon completion of authentication, the SyncML client 10 starts to transmit data 1 (first change) to the SyncML server 20 at 503. At this time, when the transmission of data 1 is successfully completed, the data 1 is normally updated in the SyncML server 20 at 504, and then, data 2 (second change) starts to transmit at 505. If the data 2 in transmission is large capacity data, the SyncML client 10 divides the data 2 into several fixed size and then transmits them in part.

By the way, during transmission of the data 2, there may be a situation where the session is abnormally stopped due to loss of network or lack of battery of terminal in the state that data transmission is not completed at 506. At this time, the SyncML server 20 stores information on an abnormally stopped session (or a session that transmission is not completed) and data transmission state information (stopped (incompletely transmitted) data management information, a data size, progress details of data (a size of transmitted data), etc.) in the abnormally stopped session at 507.

Thereafter, when a new data synchronization session is performed at 508, the SyncML client 10 creates a change history having the data 2 in the changes since the data 2 (incompletely transmitted data) is not completed in the previous session at 509, and undergoes the authentication and initialization process for synchronization with the SyncML server 20 at 510. In other words, the SyncML client 10 makes a synchronization request for the data 2, that is, requests the SyncML server 20 to notify the authentication information on the SyncML server 20 and the number of data (“1”) to be synchronized. At this time, the SyncML client 10 can request the SyncML server 20 to provide information about the previous session. In response, the SyncML server 20 transmits the stored information (information on the abnormally stopped session (or in the session that transmission is not completed) and data transmission state information in the abnormally stopped session) to the SyncML client 10 at the SyncML client's request or in the authentication and initialization process, to inform the SyncML client 10 that there was partial transmission of large capacity data (fail of data transmission) before start of the current session to learn that the current session is a resume session at 511. By doing so, the SyncML client 10 detects that there was an abnormal stop of data transmission (or transmission is not completed) in the previous session.

In this process, if it is detected that the abnormal stop has occurred in the previous session, the SyncML client 10 adjusts the transmission size of the data 2 and data offset at 512, and performs continuous transmission of the data 2 to the SyncML server 20 at 513. After that, when the transmission of the data 2 is successfully completed, the SyncML server 20 updates the data 2 at 514, thereby establishing synchronization of the data 1 and 2.

As described above, the process in which the SyncML server 20 stores the current transmission state information in the data synchronization process at the abnormal stop time (or at the time when transmission is not completed) and then exchanges information on the incompletely transmitted data with the SyncML client 10 upon start of a next session has been described by way of an example. In another example, it is possible that the SyncML client 10 stores the current transmission state information in the data synchronization process at the abnormal stop time (or at the time when transmission is not completed) and exchanges information on the incompletely transmitted data with the SyncML server 20 upon start of a next session, followed by transmitting only the remainder of the data partially transmitted to the SyncML server 20. This reduces the amount of data to be transmitted in the synchronization process upon exchange of large capacity data, synchronization time, a waste of unnecessary transactions, and so on. At this time, the information stored in the SyncML client 10 is only the one on data until it takes from the SyncML server 20 the result that the data requested for transmission has been normally received.

That is, when the transmission of large capacity data is stopped during transmission due to an abnormal stop (or incomplete transmission) in the data synchronization process, the SyncML client 10 stores information on an abnormally stopped session (or a session that transmission is not completed) and data transmission state information (stopped (incompletely transmitted) data management information, a data size, progress details of data (a size of transmitted data), etc.) in the abnormally stopped session. Further, upon start of a next synchronization session, the SyncML client 10 transmits the stored information (the information on the abnormally stopped session (or the session that transmission is not completed) and the data transmission state information in the abnormally stopped session) to the SyncML server 20 at the SyncML server 20′ request or in the authentication and initialization process, to inform the SyncML client 10 that there was partial transmission of the large capacity data before the start of the current session to know that the current session is a resume session. Thereafter, the SyncML client 10 detects data at the time when transmission is stopped by using the above information and initiates to transmit the data from the stopping time, and the SyncML server 20 taking over the data sequentially updates the data following the pre-stored data, thereby achieving synchronization.

Here, upon exchange of data between the SyncML client 10 and the SyncML server 20, the SyncML client 10 can manage the information on the abnormally stopped session (or the session that transmission is not completed) and data transmission state information (stopped (incompletely transmitted) data management information, a data size, progress details of data, etc.) in the abnormally stopped session and exchange them with the SyncML server 20, thereby enabling continuous data reception. At this time, when the SyncML client 10 exchanges session information with the SyncML server 20, it stores the session information in a specific node and manages it, and, upon start of synchronization session, the SyncML server 20 requests the SyncML client 10 to provide the information on the node, or the SyncML client 10 transmits the information to the SyncML server 20 in the authentication and initialization process. As such, the SyncML client 10 informs the SyncML server 20 that there was partial transmission of data (fail of data transmission) in the previous session (to know that the current session is a resume session), so that the SyncML server 20 enables continuous data reception from the SyncML client 10.

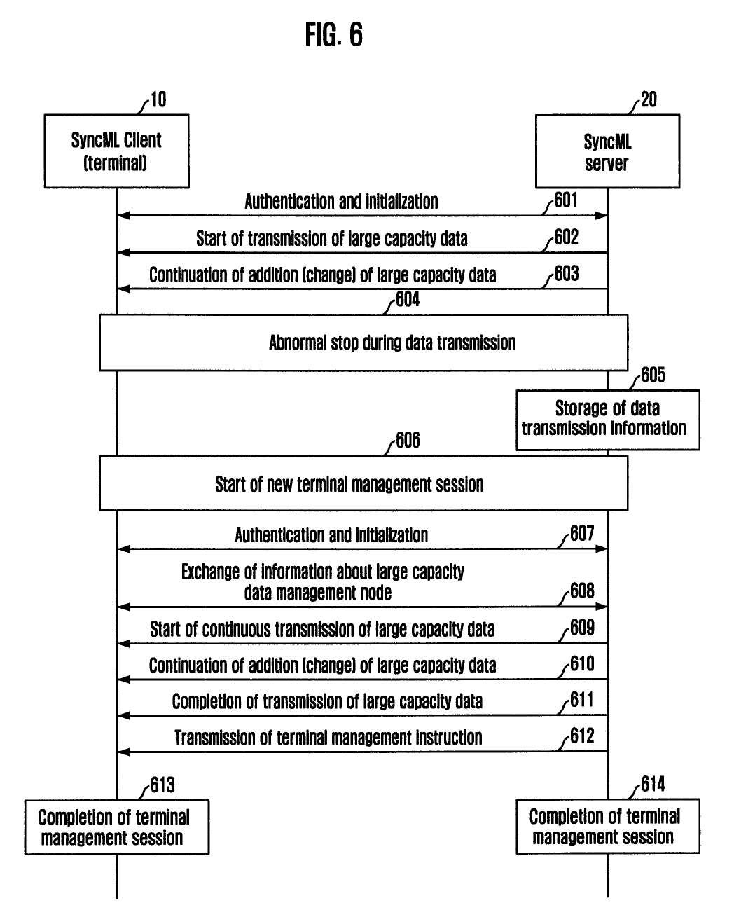

FIG. 6 is a flowchart describing a terminal management restart process in the event of abnormal stop of data transmission from a SyncML server to a SyncML client in a method for transmission of incompletely transmitted data between them in accordance with another preferred embodiment of the present invention. That is, FIG. 6 shows a process that performs continuous data reception upon fail of data transmission from the SyncML server 20 to the SyncML client 10.

According to FIG. 6, the present invention allows the SyncML server 20 to store information on the current transmission state in a terminal management process at the time of an abnormal stop (or at the time when transmission is not completed), and exchange the information on incompletely transmitted data with the SyncML client 10 upon start of a next session, followed by transmitting only the remainder of the data partially transmitted to the SyncML client 10. This reduces the amount of data to be transmitted in the terminal management process upon exchange of large capacity data, terminal management time, a waste of unnecessary transactions, and so on. At this time, the information stored in the SyncML server 20 is only the one on data until it takes from the SyncML client 10 the result that the data requested for transmission has been normally received.

In other words, when the transmission of large capacity data is stopped in the middle of transmission due to an abnormal stop (or incompletion transmission) in the terminal management process, the present invention allows the SyncML server 20 to store information on an abnormally stopped session (or a session that transmission is not completed) and data transmission state information (stopped (incompletely transmitted) data management information, a data size, progress details of data (a size of transmitted data), etc.) in the abnormally stopped session. Further, upon start of a next terminal management session, the SyncML server 20 transmits the stored information (the information on the abnormally stopped session (or the session that transmission is not completed)) and the data transmission statue information in the abnormally stopped session to the SyncML client 10 at the SyncML client 10′ request or in the authentication and initialization process, to inform the SyncML client 10 that there was partial transmission of the large capacity data (fail of data transmission) before the start of the current session to find out that the current session is a resume session. Thereafter, the SyncML server 20 detects data at the time when transmission is stopped by using the above information and initiates to transmit the data from the stopping time, and the SyncML client 10 taking over the data sequentially updates the data following the pre-stored data to perform terminal management.

Here, upon exchange of data between the SyncML server 20 and the SyncML client 10, the SyncML server 20 can manage the information on the abnormally stopped session (or the session that transmission is not completed) and data transmission state information (stopped (incompletely transmitted) data management information, a data size, progress details of data, etc.) in the abnormally stopped session and exchange them with the SyncML client 10, thereby enabling continuous data reception. At this time, when the SyncML server 20 exchanges the session information with the SyncML client 10, it stores the session information in a specific node and manages it, and, upon start of terminal management session, the SyncML client 10 requests the SyncML server 20 to offer the information on the node, or the SyncML server 20 transmits the information to the SyncML client 10 in the authentication and initialization process. As such, the SyncML server 20 informs the SyncML client 10 that there was partial transmission of data (fail of data transmission) in the previous session (to find out that the current session is a resume session), so that the SyncML client 10 enables continuous data reception from the SyncML client 10.

Now, a data transmission and continuous data reception process from the SyncML server 20 to the SyncML client 10 will be described in more detail with reference to FIG. 6. FIG. 6 shows a process opposite to the case of FIG. 5, in which the data from the SyncML server 20 to the SyncML client 10 is abnormally stopped (transmission is not completed) during transmission and continuous reception for the data (incompletely transmitted data) is performed in a next session.

First, the SyncML server 20 makes a connection to the SyncML client 10, and executes an authentication and initialization procedure at 601.

Next, the SyncML server 20 divides large capacity data into several fixed size and then transmits them in part at 602 and 603. At this time, when the session is stopped abnormally (e.g., due to loss of network or lack of battery of terminal) before the entire of large capacity data is transmitted (only part thereof is transmitted) at 604, the SyncML server 20 stores information on the abnormally stopped session (or the session that transmission is not completed) and data transmission state information (stopped (incompletely transmitted) data management information, a data size, progress details of data (size of transmitted data), etc.) in the abnormally completed session at 605.

Thereafter, upon start of a new terminal management session at 606, the SyncML server 20 is subjected to an authentication and initialization process for terminal management with the SyncML client 10 at 607. At this time, the SyncML client 10 can request the SyncML server 20 to provide information about the previous session. In response, the SyncML server 20 transmits the stored information (information on the abnormally stopped session (or the session that transmission is not completed) and data transmission state information in the abnormally stopped session) to the SyncML client 10 at the SyncML client 10's request or in the authentication and initialization process, to inform the SyncML client 10 that there was partial transmission of large capacity data (fail of data transmission) before start of the current session to learn that the current session is a resume session at 608. As such, the SyncML server 20 and the SyncML client 10 exchange information on the previous session, thereby finding out information indicating that continuous reception is possible for the data transmitted from the SyncML server 20 to the SyncML client 10 at 608 and then enabling continuous transmission/reception for the large capacity data at 609 and 610.

In succession, when the transmission of large capacity data (incompletely transmitted data) is completed at 611, the SyncML server 20 transmits terminal management instruction to the SyncML client 10 at 612, thereby completing the terminal management session between the SyncML client 10 and the SyncML server 20 at 613 and 614.

As described above, the process of allowing the SyncML server 20 to store the current status information on the terminal management process at the abnormally stopped time (or at the time when transmission is not completed) and exchange information on the incompletely transmitted data with the SyncML client 10 upon start of a next session has been described by way of an example. In another example, it is possible for the SyncML client 10 to store the current transmission state information on the terminal management process at the abnormally stopped time (or at the time when transmission is not completed) and exchange information on the incompletely transmitted data with the SyncML server 20 upon start of a next session, so that the SyncML server 20 finds out the data partially transmitted and transmits only the remainder of the data to the SyncML client 10. This reduces the amount of data to be transmitted in the terminal management process upon exchange of large capacity data, terminal management time, a waste of unnecessary transactions, and so on.

That is, when the transmission of large capacity data is stopped during transmission due to an abnormal stop (or incompletion transmission) in the terminal management process, the SyncML client 10 stores information on an abnormally stopped session (or a session that transmission is not completed) and data transmission state information (stopped (incompletely transmitted) data management information, a data size, progress details of data (a size of transmitted data), etc.) in the abnormally stopped session. Further, upon start of a next terminal management session, the SyncML client 10 transmits the stored information (the information on the abnormally stopped session (or the session that transmission is not completed)) to the SyncML server 20 at the SyncML server 20′ request or in the authentication and initialization process, to inform the SyncML server 20 that there was partial transmission of the large capacity data (fail of data transmission) before the start of the current session (that is, the current session is a resume session) to know that the current session is a resume session. Thereafter, the SyncML server 20 searches data at the time when transmission is stopped by using the above information and initiates to transmit the data from the stopping time, and the SyncML client 10 taking over the data sequentially updates the data following the pre-stored data to perform terminal management.

Here, upon exchange of data between the SyncML server 20 and the SyncML client 10, the SyncML client 10 can manage the information on the abnormally stopped session (or the session that transmission is not completed) and data transmission status information (stopped (incompletely transmitted) data management information, a data size, progress details of data, etc.) in the abnormally stopped session and exchange them with the SyncML server 20, thereby executing continuous data reception. At this time, when the SyncML client 10 exchanges the session information with the SyncML server 20, it stores the session information in a specific node and manages it, and, upon start of terminal management session, the SyncML server 20 requests the SyncML client 10 to provide the information on the node, or the SyncML client 10 transmits the information to the SyncML server 20 in the authentication and initialization process. In this way, the SyncML client 10 informs the SyncML server 20 that there was partial transmission of data (fail of data transmission) in the previous session (to learn that the current session is a resume session), enabling continuous data reception from the SyncML server 20.

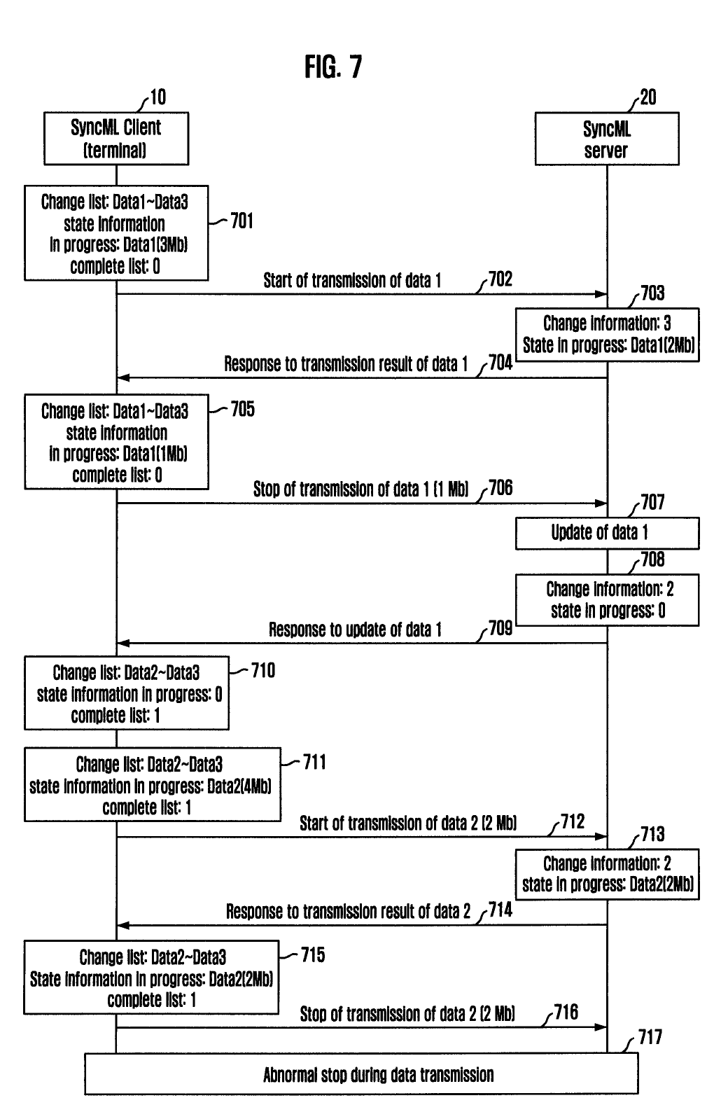

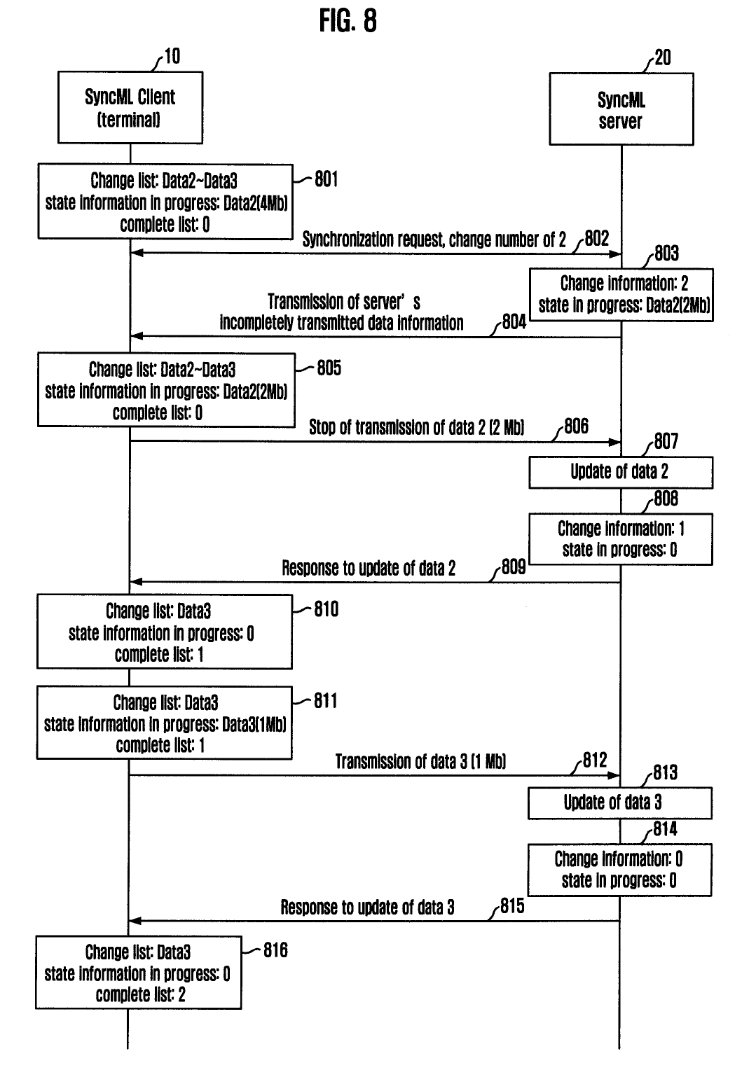

Now, a process in which the SyncML server 20 continuously receives data from the SyncML client 10 when the transmission of data from the SyncML client 10 to the SyncML server 20 is abnormally stopped during transmission in FIG. 5 will be described in detail with reference to FIGS. 7 and 8.

FIG. 7 illustrates a process in which the transmission of data is abnormally stopped during an attempt of transmitting three data (data 1 to data 3) from the SyncML client 10 to the SyncML server 20. For convenience, it is assumed that there are three data changed in the SyncML client 10 in order to perform the data synchronization task at 701. Here, the names and sizes of the respective data are as follows: “data 1 (3 Mb)”, “data 2 (4 Mb)”, and “data 3 (1 Mb)”. At this time, if it is assumed that the amount of message data that the SyncML client 10 and the SyncML server 20 can transmit is maximally 2 Mb (maximum transmission tolerable capacity), the data 1 (3 Mb) and the data 2 (4 Mb) are subjected to a large capacity data transmission process due to the size of data.

Thus, the SyncML client 10 first transmits 2 Mb of 3 Mb due to the size of the maximum message size for the data 1 to the SyncML server 20 (at this time, the change list of the SyncML client 10 is as follows: “change list: data 1 to data 3, state information in progress: data 1 (3 Mb), and complete list: 0”) at 701 and 702, and the SyncML server 20 stores the change (change information: 3, state in progress: data 1(2 Mb)) at 703 and then transmits the transmission result of 2 Mb of the data 1 to the SyncML client 10 at 704.

Next, when the SyncML client 10 receives the transmission result of 2 Mb of the data 1 from the SyncML server 20, it corrects the change list (change list: data 1 to data 3, state information in progress: data 1 (1 Mb), complete list: 0) at 705, and transmits the remainder 1 Mb of the data 1 to the SyncML server 20 at 706. In response, the SyncML server 20 updates the completed data 1 (3 Mb) in a repository at 707, it stores the above change (change information: 2, state in progress: 0) at 708 and then transmits the update result of the data 1 (3 Mb) to the SyncML client 10 at 709.

Subsequently, the SyncML client 10 takes the update result of the data 1 from the SyncML server 20 and updates the fact that the transmission of the data 1 (3 Mb) has been completed in the change list (change list: data 2 to data 3, state information in progress: 0, complete list: 1) at 710, and thereafter, prepares for transmission of the data 2.

In succession, the SyncML client 10 first transmits 2 Mb of 4 Mb of the data 2 to the SyncML server 20 (at this time, the change list of the SyncML client 10 is as follows: “change list: data 2 to data 3, state information in progress: data 2 (4 Mb), and complete list: 1”) at 711 and 712, and then, the SyncML server 20 sores the above change (change information: 2, state in progress: data 2 (2 Mb) at 713 and then transmits the transmission result of 2 Mb of the data 2 to the SyncML client 10 at 714.

Next, when the SyncML client 10 receives the transmission result of 2 Mb of the data 2 from the SyncML server 20, it corrects the change list (change list: data 2 to data 3, state information in progress: data 2 (2 Mb), complete list: 1) at 715, and tries to transmit the remainder 2 Mb of the data 2 to the SyncML server 20 at 716. However, when the SyncML server 20 does not receive the remainder 2 Mb of the data 2 due to loss of network, lack of battery of terminal or the like, the session is abnormally stopped at 717.

Thereafter, a process of proceeding with continuous reception of the previous data 2 by starting a next session will be described below in detail with reference to FIG. 8.

First, because of the abnormal stop in the previous session, the SyncML client 10 constitutes the current change list where there are two data of data 2 and data 3 (change list: data 2 to data 3, state information in progress data 2 (4 Mb), complete list: 0) at 801. Further, in the authentication and initialization process with the SyncML server 20, the SyncML client 10 notifies the SyncML server 20 that there exist two changes in 802, and the SyncML server 20 transmits, to the SyncML client 10, information indicating that data synchronization is abnormally stopped in the previous session (that is, information on the abnormally stopped session (or the session in which transmission is not completed), and data transmission state information in the abnormally stopped session at 804, based on the stored information for the previous session (that is, information on the abnormally stopped session (or the session in which transmission is not completed) and data transmission state information (change information: 2, state in progress: 2 (2 Mb))) in the abnormally stopped session at 803.

Next, the SyncML client 10 detects the transmission state of the data 2 and corrects the change list (change list: data 2 to data 3, state information in progress: data 2 (2 Mb), complete list: 0) at 805, and then transmits the remaining 2 Mb data of the data 2 to the SyncML server 20 at 806. In response, the SyncML server 20 updates the data 2 at 807, and thereafter, stores the above change (change information: 1, state in progress: 0) at 808 and then transmits the update result of the data 2 (4 Mb) to the SyncML client 10 at 809.

In succession, the SyncML client 10 accepts the update result of the data 2 from the SyncML server 20 and updates in the change list the fact that the transmission of the data 2 (total 4 Mb) has been completed (change list: data 3, state information in progress: data 0, complete list: 1) at 810, and then prepares for transmission of the data 3.

In this way, continuous reception of the data 2 is possible.

Next, the SyncML client 10 completes transmission of the remaining data 3 to the SyncML server 20 at 811 to 816. More specifically, the SyncML client 10 transmits 1 Mb of the data 3 to the SyncML server 20 (at this time, the change list of the SyncML client 10 is as follows: “change list: data 3, state information in progress: data 3 (1 Mb), and complete list: 1”) at 811 and 812, and then, the SyncML server 20 updates the completed data 3 (1 Mb) in a repository at 813 and sores the above change (change information: 0, state in progress: 0) at 814 and transmits the update result of the data 3 (1 Mb) to the SyncML client 10 at 815. In response, when the SyncML client 10 receives the update result of the data 3 from the SyncML server 20, it corrects the change list (change list: data 3, state information in progress: 0, complete list: 2) at 816.

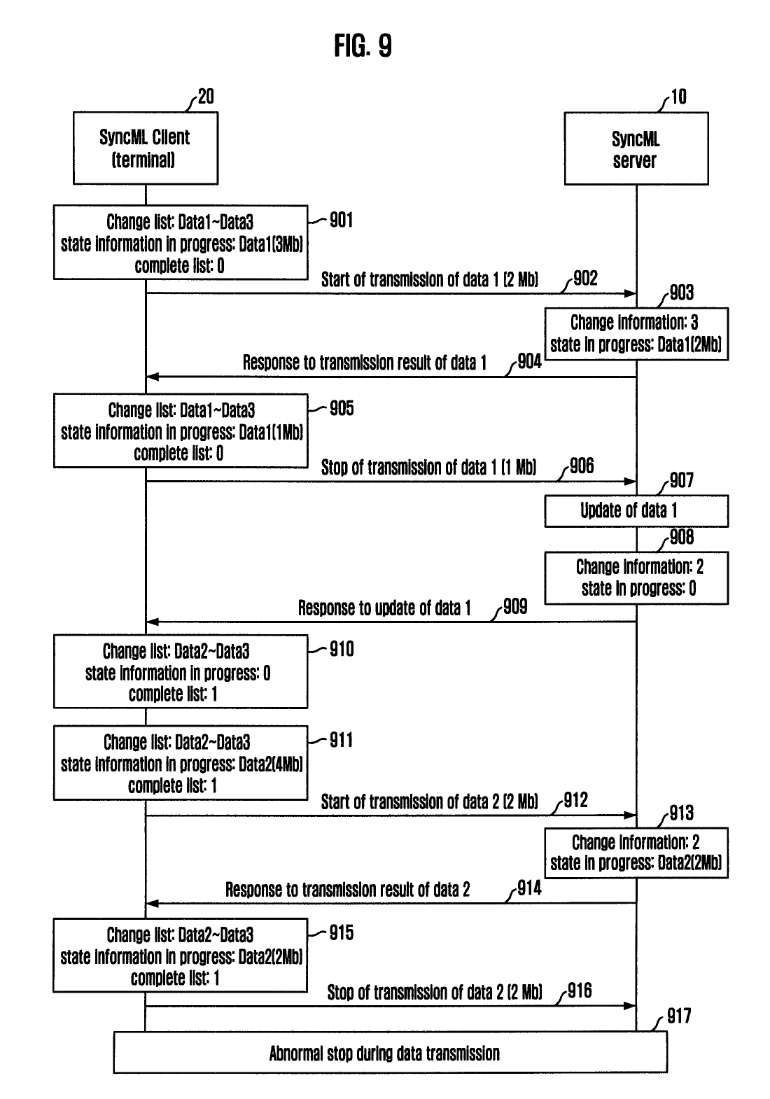

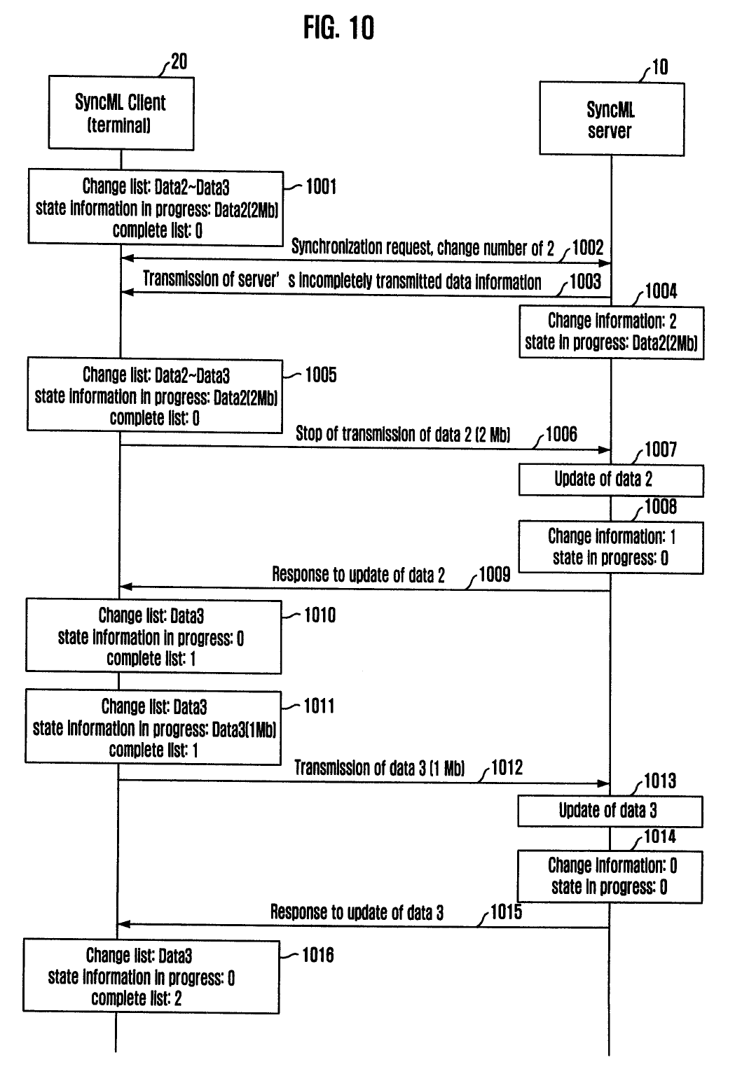

Now, a process in which the SyncML client 10 continuously receives data from the SyncML server 20 when the transmission of data from the SyncML server 20 to the client is abnormally stopped during transmission in FIG. 6 will be described in detail with reference to FIGS. 9 and 10.

FIG. 9 shows a process in which the transmission of data is abnormally stopped while the SyncML server 20 attempts to transmit three data (data 1 to data 3) to the SyncML client 10. For convenience, it is assumed that there are three data changed in the SyncML server 20 in order to perform the terminal management task at 901. Here, the names and sizes of the respective data are as follows: “data 1 (3 Mb)”, “data 2 (4 Mb)”, and “data 3 (1 Mb)”. At this time, if it is assumed that the amount of one message data that the SyncML client 10 and the SyncML server 20 can transmit is maximally 2 Mb (maximum transmission tolerable capacity), the data 1 (3 Mb) and the data 2 (4 Mb) is subjected to a large capacity data transmission process due to the size of data.

Accordingly, the SyncML server 20 first transmits 2 Mb of 3 Mb of the data 1 due to the size of the maximum message to the SyncML client 10 (at this time, the change list of the SyncML server 20 is as follows: “change list: data 1 to data 3, state information in progress: data 1 (3 Mb), and complete list: 0”) at 901 and 902, and then, the SyncML client 10 stores the above change (change information: data 3, state in progress: data 1 (2 Mb)) at 903 and transmits the transmission result of 2 Mb of the data 1 to the SyncML server 20 at 904.

Next, when the SyncML server 20 receives the transmission result of 2 Mb of the data 1 from the SyncML client 10, it corrects the change list (change list: data 1 to data 3, state information in progress: data 1 (1 Mb), complete list: 0) at 905, and transmits the remainder 1 Mb of the data 1 to the SyncML client 10 at 906. In response, after the SyncML client 10 updates the completed data 1 (3 Mb) in a repository at 907, it stores the above change (change information: 2, state in progress: 0) at 908 and then transmits the update result of the data 1 (3 Mb) to the SyncML server 20 at 909.

Subsequently, the SyncML server 20 takes the update result of the data 1 from the SyncML client 10 and updates the fact that transmission of the data 1 (3 Mb) has been completed in the change list (change list: data 2 to data 3, state information in progress: 0, complete list: 1) at 910, and thereafter, prepares for transmission of the data 2.

In succession, the SyncML server 20 first transmits 2 Mb of 4 Mb of the data 2 to the SyncML client 10 (at this time, the change list of the SyncML server 20 is as follows: “change list: data 2 to data 3, state information in progress: data 2 (4 Mb), and complete list: 1”) at 911 and 912, and then, the SyncML client 10 sores the above change (change information: 2, state in progress: data 2 (2 Mb) at 913 and transmits the transmission result of the data 2 (2 Mb) to the SyncML server 20 at 914.

Next, when the SyncML server 20 receives the transmission result of 2 Mb of the data 2 from the SyncML client 10, it corrects the change list (change list: data 2 to data 3, state information in progress: data 2 (2 Mb), completed list: 1) at 915, and tries to transmit the remainder 2 Mb of the data 2 to the SyncML client 10 at 916. However, when the SyncML client 10 does not receive the remainder 2 Mb of the data 2 due to loss of network or lack of battery of terminal, the session is abnormally stopped at 917.

Hereinafter, a process of proceeding with continuous reception of the previous data 2 by beginning a next session will be described in detail with reference to FIG. 10.

First, due to the abnormal stop in the previous session, the SyncML server 20 constitutes the current change list where there are two data of data 2 and data 3 (change list: data 2 to data 3, state information in progress: data 2 (2 Mb), complete list: 0) at 1001. At this time, since the transmission result of the forepart 2 Mb of the data 2 is received at step “914”, the change list reflecting this is maintained. Further, in the authentication and initialization process with the SyncML client 10, the SyncML server 20 notifies the SyncML client 10 that there exist two changes at 1002. At this time, the SyncML server 20 transmits, to the SyncML client 10, information indicating that data synchronization is abnormally stopped in the previous session based on the stored information for the previous session (that is, information on an abnormally stopped session (or a session in which transmission is not completed) and data transmission state information (change information: 2, state in progress: 2 (2 Mb)) in the abnormally stopped session at 1003. And, the SyncML client 10 detects the abnormal stop for the session and then corrects a list having the change applied (change information: 2, state in progress: 2 (2 Mb)) at 1004, to transit it to a state capable of performing continuous reception.

Next, the SyncML server 20 transmits the remaining 2 Mb data of the data 2 (at this time, the change list of the SyncML server 20 is as follows: “change list: data 2 to data 3, state information in progress: data 2 (2 Mb), and complete list: 0”) at 1005 and 1006. In response, the SyncML client 10 updates the data 2 at 1007 and then stores the above change (change information: 1, state in progress: 0) at 1008 and transmits the update result of the data 2 (total 4 Mb) to the SyncML server 20 at 1009.

Subsequently, the SyncML server 20 receives the update result of the data 2 from the SyncML client 10 and updates in the change list the fact that the transmission of the data 2 (total 4 Mb) has been completed (change list: data 3, state information in progress: data 0, complete list: 1) at 1010, and then prepares for transmission of the data 3.

In this manner, continuous reception of the data 2 is possible.

Next, the SyncML server 20 completes transmission of the remaining data 3 to the SyncML client 10 at 1011 to 1016. More specifically, the SyncML server 20 transmits 1 Mb of the data 3 to the SyncML client 10 (at this time, the change list of the SyncML server 20 is as follows: “change list: data 3, state information in progress: data 3 (1 Mb), and complete list: 1”) at 1011 and 1012. And then, the SyncML client 10 updates the completed data 3 (1 Mb) in a repository at 1013 and sores the above change (change information: 0, state in progress: 0) at 1014 and transmits the update result of the data 3 (1 Mb) to the SyncML server 20 at 1015. When the SyncML server 20 receives the update result of the data 3 from the SyncML client 10, it updates the change list (change information: data 3, state in progress: 0, complete list: 2) at 1016.

The continuous data receiving process set forth above can also be applied to two-way synchronization or terminal management process between the SyncML server 20 and the SyncML client 10, as well as one-way synchronization or terminal management process of the SyncML server 20 or SyncML client 10.

In addition, as described above, the present invention allows not only the SyncML server 20 to store information on the current transmission state in the data synchronization or terminal management process at the time of an abnormal stop (or at the time when transmission is not completed), and exchange the information on incompletely transmitted data with the SyncML client 10 upon start of a next session, but also the SyncML client 10 to store information on the current transmission state in the data synchronization or terminal management process at the time of an abnormal stop (or at the time when transmission is not completed), and exchange the information on incompletely transmitted data with the SyncML server 20 upon start of a next session. Accordingly, the present invention can detect data partially transmitted and can transmit only the remainder of the data.

On the other hand, the method of the present invention as mentioned above may be implemented by a software program. Further, the codes and code segments constituting the program can easily be deduced by a computer programmer skilled in the art. Also, the program prepared is stored in a computer-readable recording medium (data storage medium), and read and executed by the computer to implement the present invention. Moreover, the recording medium includes all types of storage medium that can be read by the computer.

The present application contains subject matter related to Korean Patent Application No. 2007—filed in the Korean Intellectual Property Office on Oct. 2, 2007, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A method for data transmission in a communication system, comprising:
transmitting part of data to be transmitted from one terminal to another terminal depending on a maximum transmission tolerable capacity;
when the transmission of the data is stopped during the transmission, storing information on a capacity of the partial data lastly validly transmitted from said another terminal and information on a corresponding session;
when a next session begins after stop of the current session, transmitting the information from said another terminal to said one terminal to recognize the information as a session upon restart; and
finding, at said one terminal, data at the time when the transmission is stopped, and transmitting the data following partial data at the stopping time to said another terminal.

2. A method for data transmission in a communication system, comprising:
transmitting part of data to be transmitted from one terminal to another terminal depending on a maximum transmission tolerable capacity;
when the transmission of the data is stopped during the transmission, storing information on a capacity of the partial data lastly validly transmitted from said one terminal and information on a corresponding session;
when a next session begins after stop of the current session, transmitting the information from said one terminal to said another terminal to recognize the information as a session upon restart; and
finding, at said one terminal, data at the time when the transmission is stopped, and transmitting the data following partial data at the stopping time to said another terminal.

3. The method of claim 1 or 2, wherein said one terminal informs that there is fail of data transmission during partial transmission of large capacity data before start of the current session when the next session begins after stop of the current session.

4. The method of claim 3, wherein said one terminal adjusts a transmission size of the partial data and a data offset and performs continuous transmission of the corresponding partial data to said another terminal.

5. The method of claim 4, further comprising continuously receiving, at said another terminal, the data from the time when the transmission is stopped and updating the data with the lastly validly transmitted partial data.

6. The method of claim 5, wherein the data is either synchronization data or terminal management data.

7. The method of claim 6, wherein the information is transmitted from said one terminal to said another terminal at said another terminal's request or in an authentication initialization process upon start of a next session after strop of the current session.

8. The method of claim 6, wherein said one terminal is a SyncML client, and said another terminal is a SyncML server.

9. The method of claim 6, wherein said one terminal is a SyncML server, and said another terminal is a SyncML client.

10. The method of claim 9, wherein the information is information on data until the SyncML server receives the result that the data requested for transmission is normally received from the SyncML client.

11. A computer-readable storage medium, in a communication system having a processor for transmitting date incompletely transmitted, which stores a software program for realizing the functions comprising:
when the transmission of the data is stopped during the transmission, storing information on a capacity of the partial data lastly validly transmitted from said another terminal and information on a corresponding session;
when a next session begins after stop of the current session, transmitting the information from said another terminal to said one terminal to recognize the information as a session upon restart; and
finding, at said one terminal, data at the time when the transmission is stopped, and transmitting the data following partial data at the stopping time to said another terminal.

12. A computer-readable storage medium, in a communication system having a processor for transmitting data incompletely transmitted, which stores a software program for realizing the functions comprising:
transmitting part of data to be transmitted from one terminal to another terminal depending on a maximum transmission tolerable capacity;
when the transmission of the data is stopped during the transmission, storing information on a capacity of the partial data lastly validly transmitted from said one terminal and information on a corresponding session;
when a next session begins after stop of the current session, transmitting the information from said one terminal to said another terminal to recognize the information as a session upon restart; and
finding, at said one terminal, data at the time when the transmission is stopped, and transmitting the data following partial data at the stopping time to said another terminal.
